(19) United States
(12) Patent Application Publication
(10) Pub. No.: US 2009/0042073 A1
(43) Pub. Date: Feb. 12, 2009

(54) FUEL CELL SYSTEM CAPABLE OF SUPPLYING POWER OF VARIOUS LEVELS AND METHOD OF OPERATING THE SAME

(75) Inventors: Ji-rae KIM, Seoul (KR); Young-jae Kim, Seoul (KR); Jin-ho Kim, Seoul (KR); Young-soo Joung, Anseong-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/172,365

(22) Filed: Jul. 14, 2008

(30) Foreign Application Priority Data
Aug. 6, 2007 (KR) 2007-78696

(51) Int. Cl. H01M 8/04

(52) U.S. Cl. 429/23; 429/13

(57) ABSTRACT

A fuel cell system capable of supplying power at various levels and a method of operating the same includes a power unit having a stack, a power generation unit including unit cells, and a switch group to connect the unit cells in series or in parallel wit. The switch group may include a first switch to connect anodes of two neighboring unit cells, a second switch to connect cathodes of the two neighboring unit cells, and a third switch to connect the two neighboring unit cells in series.

### CROSS-REFERENCE TO RELATED APPLICATION

This application claims the benefit of Korean Patent Application No. 2007-78696, filed Aug. 6, 2007 in the Korean Intellectual Property Office, the disclosure of which is incorporated herein by reference.

### BACKGROUND OF THE INVENTION

1. Field of the Invention

Aspects of the present invention relate to a power generation apparatus, and more particularly, to a fuel cell system capable of supplying power of various levels and a method of operating the same.

2. Description of the Related Art

A fuel cell is basically a power generation system to produce electricity in which electricity and water are produced through a reaction between hydrogen and oxygen.

A fuel cell system often used as a portable compact power source is a direct methanol fuel cell (DMFC) system, which produces electricity using methanol and oxygen from air. Although efficiency of the DMFC system is lower than that of a fuel cell system that directly uses hydrogen and oxygen, the size of the DMFC system is less than that of such a fuel cell system. Accordingly, the DMFC system is suitable for mobile devices.

However, since an output voltage of a power unit is very low, it is difficult to supply sufficient output voltage for electronic devices such as notebook computers, mobile phones, and the like without boosting the output voltage. Accordingly, the output voltage of the fuel cell system is boosted to a predetermined level by stacking the unit cells of the power unit in series and is adjusted to a voltage that is required by the electronic device by using a DC-DC converter.

However, when the output voltage is boosted by using the DC-DC converter, real power generated by the power unit is not fully supplied to the electronic device due to losses from the conversion efficiency of the DC-DC converter. Further, the conversion efficiency of the DC-DC converter becomes lower as the boosting ratio of the output voltage of the power unit becomes greater by using the DC-DC converter.

Thus, for existing fuel cell systems that use the DC-DC converter, the output voltage is fixed to a predetermined voltage. This indicates that electronic devices to which the existing fuel cell system can be applied to are limited.

### SUMMARY OF THE INVENTION

Example embodiments provide a fuel cell system to supply power of various levels that is capable of improving efficiency of transmitting power from a power unit to a load. Also, example embodiments provide a method of operating the fuel cell system.

Aspects of the present invention provide a power unit of a fuel cell system having a power generation unit comprising unit cells, and a switch group to connect the unit cells in series or in parallel.

According to aspects of the present invention, the switch group may comprise a first switch connected between anodes of neighboring unit cells and a second switch connected between cathodes of the neighboring unit cells. According to aspects of the present invention, the switch group may further comprise a third switch connected between electrodes of the neighboring unit cells, wherein the electrodes have polarities opposite to each other.

According to aspects of the present invention, the fuel cell system may be a direct methanol fuel cell or a proton exchange membrane fuel cell system. According to aspects of the present invention, the switch group may be included in a switch network separate from the unit cells. According to aspects of the present invention, the switch network may be separate from the power generation unit. According to aspects of the present invention, some of the unit cells may be connected in parallel with one another, and the other of the unit cells may be connected in series. According to aspects of the present invention, the power generation unit may be a unique boost unit between the power generation unit and a load to which the fuel cell system is installed.

Aspects of the present invention provide a fuel cell system including a power unit to produce power, wherein the power unit includes a power generation unit comprising unit cells, a switch group to connect the unit cells in series or in parallel with one another. According to aspects of the present invention, the switch group and a switch network may be the same as the above.

Aspects of the present invention provide a method of operating a fuel cell system having a system control unit and a power generation unit comprising unit cells, the method comprising: setting a voltage and connecting the unit cells so as to produce the set voltage. According to aspects of the present invention, the setting of the voltage may comprise recognizing a load and determining an operating voltage of the load as a voltage to be produced by the fuel cell system. According to aspects of the present invention, the unit cells may be connected in series and/or in parallel with one another. According to aspects of the present invention, a switch group may be included among the unit cells, and the unit cells are connected by controlling the switch group. According to aspects of the present invention, the switch group may be included in a switch network or the system control unit. According to aspects of the present invention, the switch group may comprise two switches for connecting the two unit cells in series and one switch for connecting the two unit cells in parallel with each other. According to aspects of the present invention, the method may further comprise determining whether an output voltage of the power generation unit is the same as the set voltage and supplying the output voltage to the load when the output voltage is the same as the set voltage and newly establishing connections among the unit cells when the output voltage is not the same as the set voltage.

According to aspects of the present invention, each switch group may include a switch connected between anodes of neighboring unit cells, a switch connected between cathodes of the neighboring unit cells, and a switch connected between electrodes having opposite polarities of the neighboring unit cells. According to aspects of the present invention, an output voltage of the power generation unit may be adjusted to a voltage required by a load by controlling on and off states of the switches.

Thus, the fuel cell system may supply the voltage required by the load without a DC-DC converter. In addition, since it is possible to boost a voltage by controlling the on and off states of the switches, it is possible to prevent a loss of power caused by boosting the voltage. Moreover, since the fuel cell system does not include the DC-DC converter, it is possible to reduce a volume of the fuel cell system.

Various devices may be applied since the fuel cell system can supply output voltage of various levels. For example, the fuel cell system may be applied to electronic products, for example, portable electronic communication devices, such as mobile phones, personal digital assistants (PDA), global positioning systems (GPS), notebook computers, and the like.

Surely, although a conventional fuel cell system can be applied by boosting and lowering the output voltage to a required voltage by using a DC-DC converter, a considerable amount of power loss occurs depending on the conversion efficiency. Accordingly, the practical use of the conventional fuel cell system is largely limited. Since the fuel cell system does not use a conventional DC-DC converter but uses switches included among unit cells so as to output a predetermined voltage, it is possible to diversify the method of adjusting the voltage.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a fuel cell system according to one example embodiment;

FIG. 2 is a top plan view illustrating a cell array including switches which are included in a power generation unit of FIG. 1 according to one example embodiment;

FIG. 3 is a circuit diagram illustrating a part of a cell array including the switches of FIG. 2 connected to a load according to aspects of the present invention;

FIG. 4 is a circuit diagram illustrating the switches of FIG. 3 connected in series or in parallel according to aspects of the present invention;

FIG. 5 is a circuit diagram illustrating the switches of FIG. 3 connecting the cells in series;

FIG. 6 is a top plan view illustrating a power generation unit of FIG. 2 including sixty unit cells;

FIG. 7 is a circuit diagram illustrating the switch network of FIG. 1;

FIG. 8 is a graph illustrating changes of current density in an experiment of boosting a voltage in a fuel cell system according to one example embodiment;

FIG. 9 is a graph illustrating changes in current density in an experiment of boosting a voltage in a fuel cell system that includes a DC-DC converter;

FIG. 10 is a flowchart of a method of operating a fuel cell system according to one example embodiment; and

FIG. 11 is a circuit diagram illustrating relations among components that affect the determination of a suitable voltage required for a load connected to the fuel cell system according to one example embodiment.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

As used herein, the term “and/or” includes any and all combinations of one or more of the associated listed items. It will be understood that when an element is referred to as being “connected” to another element, it may be directly connected to the other element or intervening elements may be present. In contrast, when an element is referred to as being “directly connected” to another element, there are no intervening elements present. Other words used to describe the relationship between elements should be interpreted in a like fashion (e.g., “between” versus “directly between”, “adjacent” versus “directly adjacent”, etc.).

A fuel cell system (hereinafter, referred to as a system according to an embodiment of the present invention) capable of supplying power of various levels according to an embodiment of the present invention will be described.

Referring to FIG. 1, the system according to an embodiment of the present invention includes a power unit 100, including a stack (not shown) to generate power to be supplied to a load 25, and a cartridge 20 that contains fuel to be supplied to the power unit 100. The power unit 100 may also include a balance of plant (BOP) unit 10, a power generation unit 12, a switch network 14, and a system control unit 16. The BOP unit 10 may include elements participating in supplying the fuel from the cartridge 20 to the power generation unit 12, for example, pumps, valves, and the like, and supporting elements needed for a normal operation of the power generation unit 12, for example, a water tank or a heat dissipating fan. The power generation unit 12 generates power by using air and the fuel supplied through the BOP unit 10. The power generation unit 12 includes a plurality of monopolar type unit cells or stack type unit cells. The switch network 14 may include a switch array consisting of a plurality of switches. The plurality of switches serve to open or close connections between two anodes, between two cathodes, and between a cathode and an anode of the plurality of unit cells included in the power generation unit 12. The switch network 14 controls the switch array so that the plurality of cells of the power generation unit 12 are connected in series or in parallel in response to a signal from the system control unit 16. The signal transmitted from the system control unit 16 to the switch network 14 may represent a power level required by the load 25. Thus, when the signal is transmitted from the system control unit 16 to the switch network 14, the switch network 14 controls the on and off states of switches in the switch array. The cells of the power generation unit 12 are connected in series or in parallel according to the states of the switches in the switch array so that the power generated by the power generation unit 12 corresponds to the power level represented by the signal.

The on and off states of the switches in the switch network 14 may be controlled in various manners. For example, correlation data between the signal transmitted from the system control unit 16, which is a power level required by the load, and on and off states of the switches included in the switch network 14 corresponding to the signal may be input into the switch network 14. When a signal is transmitted from the system control unit 16, the switch network 14 can set the on and off states of the switches according to the signal using the correlation data.

On the other hand, the correlation data may be stored in the system control unit 16. In such case, the system control unit 16 can directly control the switch array of the switch network 14.

Further, the on and off states of the switches in the switch network 14 can be controlled by the system control unit 16 in real time. For this, the number of cells included in the power generation unit 12 and data on minimum power, maximum power, and mean power of a unit cell are all stored on the system control unit 16. The system control unit 16 can determine an approximate value for the power level that can be generated by combining the cells included in the power generation unit 12 in series or in parallel with one another by using the aforementioned data. Accordingly, when the power level required by the load 25 is determined, the system control unit 16 can immediately determine the number of cells to be connected in series and the number of cells to be connected in parallel among the cells of the power generation unit 12. A signal is transmitted from the system control unit 16 to the switch network 14 based on this determination, and the switches located among the cells are switched on or off in response to the signal. Accordingly, the cells of the power generation unit 12 are connected in series or in parallel with one another to produce a power level_to be supplied to the load according to the signal.

The system control unit 16 can use the average power rather than the minimum power or maximum power of the unit cell to calculate a power level that can be generated by the power generation unit 12. In addition, when the power required by the load 25 is generated in real time, the power that is optimally generated by the power generation unit 12 may be slightly greater or less than the power level required by the load 25. In this case, a unit that adjusts the power level generated by the power generation unit 12 to the power level required by the load, for example, a DC-DC converter may be selectively included between the power generation unit 12 and the load 25.

Subsequently, the system control unit 16 controls the entire operation of the power unit 100 and transmits an operation signal to internal components, so that the internal components operate efficiently. In addition, the system control unit 16 recognizes that the cartridge 20 is mounted thereon and controls an amount of fuel supplied from the cartridge 20 to the power generation unit 12 according to the operational status of the power generation unit 12.

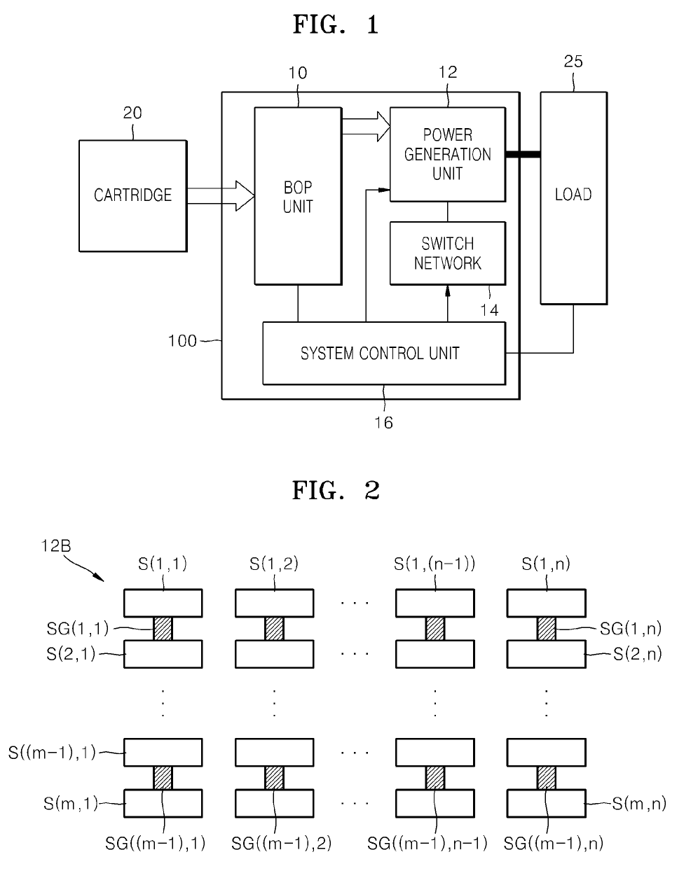

FIG. 2 illustrates an example of an array of cells with a monopolar structure of the power generation unit illustrated in FIG. 1. Referring to FIG. 2, unit cells S(1,1) to S(m,n) constitute an m by n matrix (m and n respectively =1, 2, 3, . . . ). For example, the number of unit cells S(1,1) to S(m,n) may be one, four, eight, sixty or greater. S(m,n) indicates a unit cell located at an m-th row and an n-th column. Accordingly, S(1,2) indicates a unit cell located at a first row and a second column. A plurality of switch groups SG(1,1) to SG((m-1),n) are located among the plurality of unit cells S(1,1) to S(m,n). SG((m-1),n) indicates a switch group that connects a unit cell S(m,n) located at an m-th row and an n-th column and a unit cell S((m-1),n) located at an (m-1)-th row and an n-th column. Accordingly, SG(1,1) indicates a switch group that connects a unit cell S(2,1) located at a second row and a first column and a unit cell S(1,1) located at a first row and a first column. Each switch group connects two neighboring unit cells in a column. Each switch group may include a switch for connecting electrodes of the two neighboring unit cells which have the same polarity and a switch for connecting electrodes of the two neighboring unit cells which have polarities opposite to each other. For example, a first switch group SG(1,1) that connects the first unit cell S(1,1) located at the first row and the first column and a second unit cell S(2,1) located at a second row and a first column may include a switch for connecting anodes of first and second unit cells S(1,1) and S(2,1), a switch for connecting cathodes of the first and second unit cells S(1,1) and S(2,1), and a switch for connecting an anode of the first unit cell S(1,1) and a cathode of the second unit cell S(2,1). The first switch group SG(1,1) may further include a switch for connecting a cathode of the first unit cell S(1,1) and an anode of the second unit cell S(2,1). The switch network 14 comprises the switches included in the plurality of switch groups SG(1,1) to SG((m-1),n).

Although in FIG. 2, the switch groups SG(1,1) to SG((m-1),n) connect two neighboring unit cells in an nth column, the switch groups SG(1,1) to SG((m-1),n) may serve to connect two neighboring unit cells in an mth row. In addition, the switch groups SG(1,1) to SG((m-1),n) may include switches that connect two neighboring unit cells in an mth row and two neighboring unit cells in an nth column.

The unit cells S(1,1) to S(m,n) may be connected in series or in parallel with one another or connected in a mixed manner of serial connections and parallel connections via the switch groups SG(1,1) to SG((m-1),n).

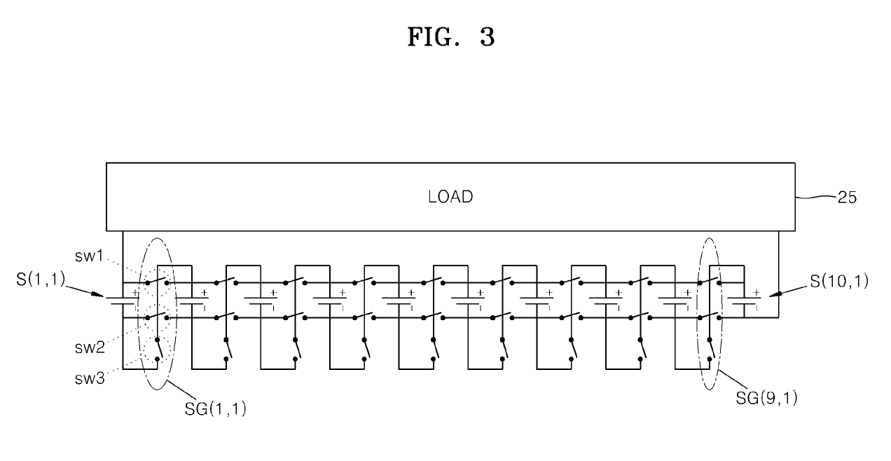

FIG. 3 is a circuit diagram illustrating a part of the unit cells S(1,1) to S(m,n) of FIG. 2. In FIG. 3, a unit cell is shown by the circuit symbol. In FIG. 3, for convenience, it is assumed that the unit cells S(1,1) to S(m,n) of FIG. 2 are constructed with ten rows and n columns, and only unit cells S(1,1) to S(10,1) located in the first column are shown. The circuit structure of the first column may be identically applied to another nth column or mth row.

Referring to FIG. 3, an anode of a first unit cell S(1,1) located in the first row and the first column is connected to the load 25. Then, a cathode of the tenth unit cell S(10,1) located in the tenth row and the first column is also connected to the load 25. A first switch SW1 connects anodes of the first and second unit cells S(1,1) and S(2,1). A second switch SW2 connects cathodes of the first and second unit cells S(1,1) and S(2,1). A third switch SW3 connects the cathode of the first unit cell S(1,1) and the anode of the second unit cell S(2,1). The first to third switches SW1 to SW3 may be located between neighboring unit cells of the first to tenth unit cells S(1,1) to S(10,1). Each of first to ninth switch groups SG(1,1) to SG(9,1) includes the first to third switches SW1 to SW3. The first and second switches SW1 and SW2 connect two neighboring unit cells of the first to tenth unit cells S(1,1) to S(10,1) in parallel. The third switch SW3 connects two neighboring unit cells of the first to tenth unit cells S(1,1) to S(10,1) in series.

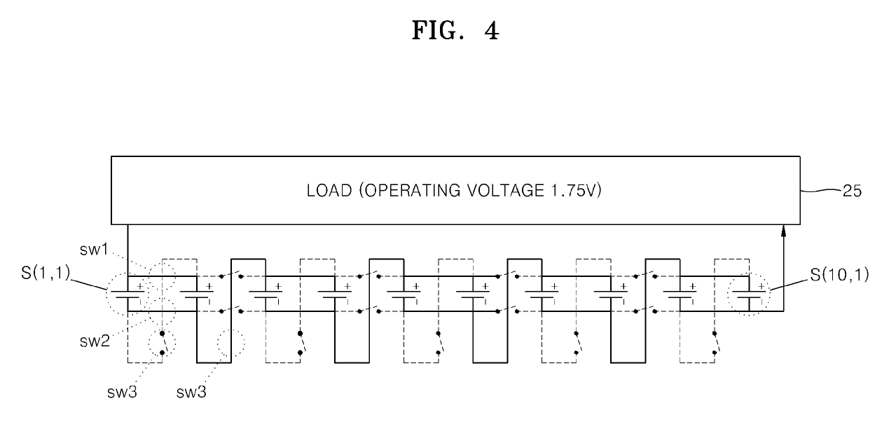

FIG. 4 illustrates a case where the first to tenth unit cells S(1,1) to S(10,1) of FIG. 3 are connected through serial and parallel connections so as to supply a voltage as required by the load 25.

Referring to FIG. 4, the first and second unit cells S(1,1) and S(2,1) are connected in parallel with each other, the third and fourth unit cells S(3,1) and S(4,1) are connected in parallel with each other, the fifth and sixth unit cells S(5,1) and S(6,1) are connected in parallel with each other, the seventh and eighth unit cells S(7,1) and S(8,1) are connected in parallel with each other, and the ninth and tenth unit cells S(9,1) and S(10,1) are connected in parallel with each other. However, the second and third unit cells S(2,1) and S(3,1) are connected in series, the fourth and fifth unit cells S(4,1) and S(5,1) are connected in series, the sixth and seventh unit cells S(6,1) and S(7,1) are connected in series, and the eighth and ninth unit cells S(8,1) and S(9,1) are connected in series. Such connections can be recognized through corresponding on and off states of the first to third switches SW1 to SW3.

In FIG. 4, when an output voltage of a unit cell S(m,n) is, for example, 0.35 V, two neighboring unit cells that are connected in parallel produce an output voltage of 0.35 V. The number of cell-groups including two unit cells that are connected in parallel with each other is five, and the five cell-groups are connected in series. Thus, the total output voltage of the first to tenth unit cells S(1,1) to S(10,1) is 1.75 V (i.e., 0.35×5=1.75 V). Such voltage may be required by the load 25.

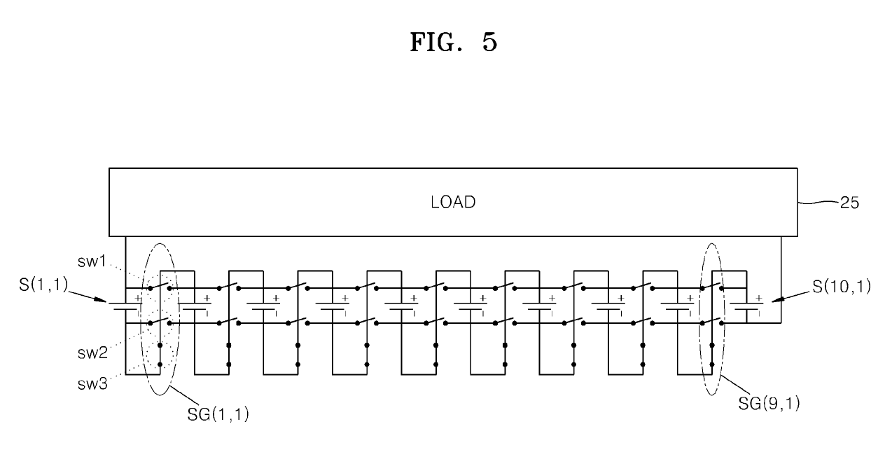

FIG. 5 illustrates a case in which the first to tenth unit cells S(1,1) to S(10,1) of FIG. 3 are connected in series. Referring to FIG. 5, in the first to ninth switch groups SG(1,1) to SG(9,1), the first and second switch SW1 and SW2 are switched off, and the third switch SW3 is switched on. Accordingly, the first to tenth unit cells S(1,1) to S(10,1) are connected in series. When each unit cell S(m,n) produces an output voltage of 0.35 V, the total output voltage of the first to tenth unit cells S(1,1) to S(10,1) is 3.5 V (i.e., 0.35×10=3.5 V).

The connection methods of FIG. 4 and FIG. 5 are not limited thereto such that the connection methods may be applied to a case where the number of unit cells is greater or less than ten.

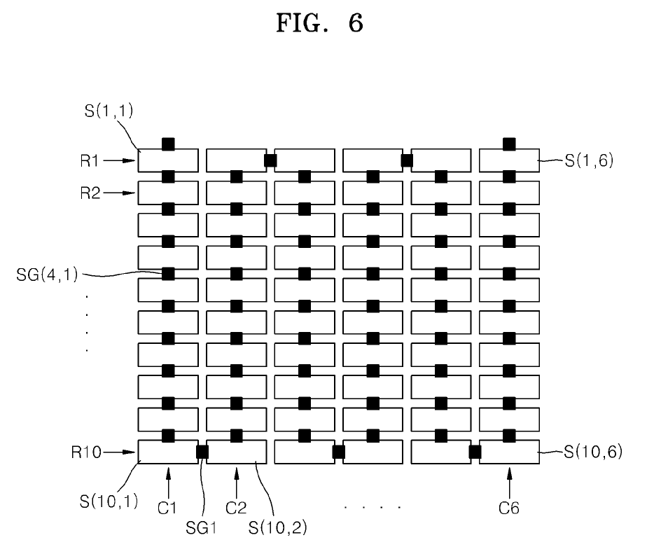

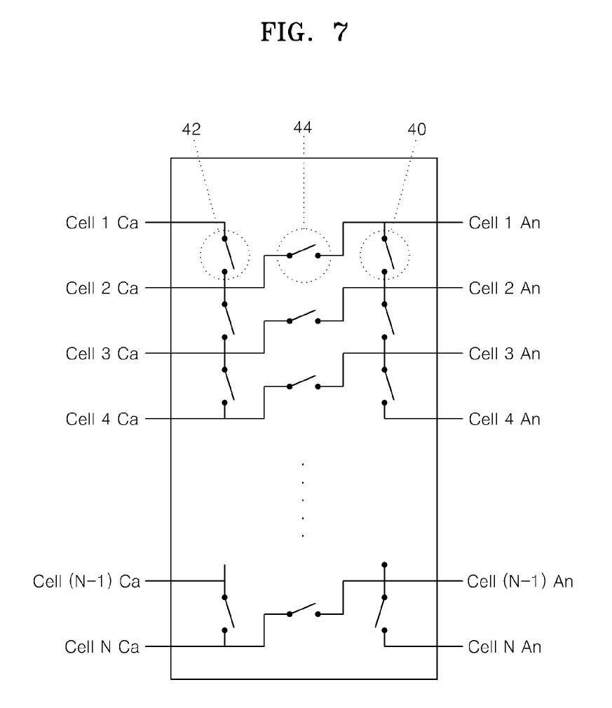

FIG. 6 illustrates a case in which the number of rows (m) is ten, and the number of columns (n) is six in a 10 by 6 matrix of unit cells, similar to FIG. 2. The 10 by 6 matrix includes sixty unit cells S(m,n) arrayed in a monopolar structure. Referring to FIG. 6, unit cells S(m,n) of each column from C1 to C6 are connected in parallel. However, two neighboring columns, for example, first and second columns C1 and C2 are connected in series. Two neighboring columns are connected in series through a switch group located between neighboring cells at a first or tenth row R1 or R10 of the neighboring columns. For example, a first serial switch group SG1 connects the unit cells S(10,1) and S(10,2) in series, i.e., the first serial switch group SG1 connects a unit cell S(10,1) that is located at a first column C1 and a tenth row R10 and a unit cell S(10,2) that is located at a second column C2 and a tenth row R10. The first serial switch group SG1 may include three switches. The three switches may have the same structures as the first to third switches SW1 to SW3 included in the switch groups SG(m-1,n) in FIG. 4 and FIG. 5.

In FIG. 6, a cathode of a unit cell S(1,1) located at a first row and a first column and an anode of a unit cell S(1,6) located at a first row and a sixth column are connected to the load 25. However, aspects of the present invention are not limited thereto such that an anode of the unit cell S(1,1) may be connected to the load 25 and a cathode the unit cell S(1,6) may be connected to the load 25.

When a stabilized average output voltage of each unit cell S(m,n) is 0.35 V, in a case where the sixty unit cells S(1,1) to S(10,6) are connected in series and in parallel with one another as shown in FIG. 6, an output voltage of each column C1 to C6 in which cells are connected in parallel with one another is 0.35 V. Since the columns C1 to C6 are connected in series, an output voltage of the total number of unit cells is 0.3×6=2.1 V.

On the other hand, in FIG. 6, the switch group for connecting two neighboring unit cells in each column C1 to C6 may serve to connect two neighboring unit cells not in series but in parallel with each other. In such a case, the sixty unit cells S(1,1) to S(10,6) are connected in series. Therefore, a total output voltage of the sixty unit cells S(1,1) to S(10,6) is 0.35 V×60=21 V. Such output voltage corresponds to a voltage level that is required by notebook computers. In a case where the number of unit cells is greater than sixty, the output voltage may greater than 21 V.

On the other hand, it is possible to obtain various output voltages by adjusting the number of unit cells to be connected in series and the number of unit cells to be connected in parallel with one another among the sixty unit cells S(1,1) to S(10,6) of FIG. 6. That is, the output voltage can be boosted or lowered.

For example, the sixty unit cells S(1,1) to S(10,6) of FIG. 6 may be divided into twelve groups each including five unit cells. When each of the unit cells S(1,1) to S(10,6) produces an output voltage of 0.35 V, and the five unit cells of each group are connected in parallel, and the twelve groups are connected in series, an output voltage of the sixty unit cells S(1,1) to S(10,6) is 4.2 V. Such output voltage corresponds to a voltage level that is required by a mobile phone or a personal digital assistant (PDA).

FIG. 7 illustrates an example of the switch network 14 of FIG. 1. In FIG. 7, “Cell 1 Ca” indicates a cathode of a first unit cell, and “Cell 1 An” indicates an anode of the first unit cell. “Cell N Ca” indicates a cathode of an n-th unit cell, and “Cell N An” indicates an anode of the nth unit cell. In addition, a first switch 40 connects anodes of two neighboring unit cells. The first switch 40 corresponds to the first switch SW1 of FIG. 4 or FIG. 5. In addition, a second switch 42 connects cathodes of two neighboring unit cells. The second switch 42 corresponds to the second switch SW2 of FIG. 4 or FIG. 5. In addition, a third switch 44 connects electrodes of two neighboring unit cells, which have different polarities. The third switch 44 corresponds to the third switch SW3 of FIG. 4 or 5. On and off states of the first, second, and third switches 40, 42, and 44 determine whether the cells are connected in parallel or series.

Next, an experiment to compare an output voltage of the power generation unit 12 boosted by changing a configuration of serial and parallel connections of the unit cells S(m,n) by using the switches as described above with an output voltage boosted by using a DC-DC converter according to a conventional technique is described. The experiment was performed as follows:

First, four unit cells were similarly formed through a same procedure. The four unit cells were connected in series in a circuit to form a stack. A first unit fuel cell constructed with the four unit cells connected in series was operated by supplying one mole of methanol to an anode and supplying oxygen to a cathode by using a pump. The oxygen was supplied by exposing the cathode to air. A temperature of the first unit fuel cell was maintained at about 40° C. Then, the total voltage of the first unit fuel cell was maintained at 1.4 V.

Two first unit fuel cells were manufactured and current densities of the two first unit fuel cells were measured. The current densities of the two first unit fuel cells were 66.5 mA/cm² and 64.6 mA/cm², respectively. Accordingly, a mean current density was 65.5 mA/cm². The mean current density value was used as a current density of the first unit fuel cell.

Next, two second unit fuel cells each constructed with eight unit cells connected in series were manufactured through the same procedure as the two first unit fuel cells. The two second unit fuel cells were operated under the same conditions as the first unit fuel cells. According to results of evaluating performance of the two second unit fuel cells, current densities of the two second unit fuel cells were 69.5 mA/cm² and 65.8 mA/cm², respectively. Accordingly, a mean current density was 67.6 mA/cm². The mean current density value was used as a current density of the second unit fuel cell. In addition, the total voltage of the second unit fuel cell was maintained at 2.8 V.

As illustrated in Table 1, when the current densities of the first and second unit fuel cells are compared to each other, the current density of the second unit fuel cell is higher than that of the first unit fuel cell by about 3%. This may represent an experimental error rather than representing improved performance of the second unit fuel cell.

Specifically, since the number of unit cells included in the second unit fuel cell is twice the number of unit cells included in the first unit fuel cell, the number of switches, which generate resistance therein, which are included in the second unit fuel cell is also twice the number of switches included in the first unit fuel cell. Thus, if the unit cells of the first and second unit fuel cell have the same performance, the performance of the second unit fuel cell is generally lower than that of the first unit fuel cell.

However, the performance of the second unit fuel cell has increased. This is because the resistance between unit cells in a circuit is generally small. Accordingly, it may be concluded that the performance of the second unit fuel cell has not been reduced due to the resistance.

Next, output voltages of the first and second unit fuel cells were boosted to 4.2 V, which may be an operating voltage of a mobile phone, by using a DC-DC converter, and current densities were measured. The measurements were taken for twenty hours.

The experimental results are summarized in the following Table 1.

TABLE 1

| | | First unit | Second |
|---|---|---|---|
| | | fuel cell | unit fuel |
| | | (4 cells) | cell (8 cells) |
| Boost | Operation voltage(V) | 1.4 | 2.8 |
| experiment | Current density 1(mA/cm²) | 66.5 | 69.5 |
| result using | Current density 2(mA/cm²) | 64.6 | 65.8 |
| unit fuel cell | Mean current | 65.5 | 67.6 |
| | density(mA/cm²) | | |
| | Current density | — | 3.2 |
| | increase and decrease(%) | | |
| | Rate of performance | 3.2 | |
| | increase and decrease | | |
| | with respect to | | |
| | voltage increment | | |
| Boost | Operation voltage(V) | 4.2 | |
| experiment result | Current density(mA/cm²) | 35 | 55 |
| using | Current density | −46.6 | −18.6 |
| DC-DC converter | increase and decrease(%) | | |
| | Rate of performance | −23.3 | −37.3 |
| | increase and decrease | | |
| | with respect to | | |
| | voltage increment | | |

In Table 1, “current density 1” indicates a current density of one of the two first unit fuel cells and a current density of one of the two second unit fuel cells, and “current density 2” indicates a current density of the other of the two first unit fuel cells and a current density of the other of the two second unit fuel cells.

Referring to Table 1, it can be seen that current densities of the first and second unit fuel cells are 64.6 mA/cm² and 65.8 mA/cm², respectively. The current densities are not substantially different from each other. Therefore, the current densities are not substantially different from each other when the output voltages are boosted by adjusting configurations of serial and parallel connections among the unit cells.

On the other hand, when the output voltage of the first unit fuel cell was boosted to 4.2 V by using the DC-DC converter (hereinafter, referred to as a first case), the current density was 35 mA/cm². The current density was smaller than the average current density of the first unit fuel cell, 65.5 mA/cm², by 46%. In addition, when the output voltage of the second unit fuel cell was boosted to 4.2 V by using the DC-DC converter (hereinafter, referred to as a second case), the current density was 55 mA/cm². The current density was smaller than the average current density of the second unit fuel cell, 67.6 mA/cm², by 18%.

However, because the current density measured in the case where the output voltage was boosted by using unit cells was not compared with the current density measured in the case where the output voltage was boosted by using the DC-DC converter under the same voltage conditions, i.e., the voltages were differently raised in the first and second cases, the comparison may be not accurate.

Accordingly, a rate of a performance increase and decrease (or a rate of current density increase and decrease) with respect to a voltage increment was measured to provide an accurate comparison. The measurement results are summarized in Table 1. Specifically, when the voltage of 1.4 V of the first unit fuel cell was boosted by 1.4 V (100%) to 2.8 V using the second unit fuel cell, the rate of the performance increase and decrease with respect to the voltage increment was +3.2. This indicates that as the voltage increment increases, the current density also increases when the voltage is boosted by using unit cells.

In the first case, the voltage was boosted by 2.8 V (200%) from 1.4 V to 4.2 V, and the current density was lowered by 46.6% from 65.5 mA/cm² to 35 mA/cm². Thus, the rate of the performance increase and decrease with respect to the voltage increment was −23.3, i.e., a performance decrease of 23.3.

In the second case, the voltage was boosted by 1.4 V (50%) from 2.8 V to 4.2 V, and the current density was lowered by 18.6% from 67.6 mA/cm² to 55 mA/cm². Thus, the rate of the performance increase and decrease with respect to the voltage increment was −37. These results are different from results obtained via the comparison of the rate of the performance increase and decrease, and it is possible to conclude that the rate of the performance decrease of the first case is lower than that of the second case when considering the rate of the performance increase and decrease with respect to the voltage increment.

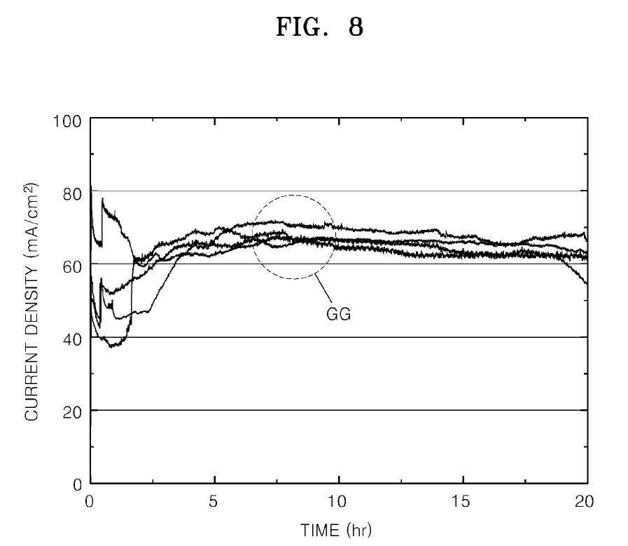

FIG. 8 illustrates current densities of the first and second unit fuel cells in the aforementioned experiments. In FIG. 8, a group of graphs represent current densities of the two first unit fuel cells and the two second unit fuel cells. Referring to FIG. 8, it can be noted that the current densities of the first and second unit fuel cells were greater than 60 mA/cm². The group of the graphs is clustered, which illustrates that the current densities of the first and second unit fuel cells were not considerably different from each other. Accordingly, although the output voltage of the first unit fuel cell was boosted by using the second unit fuel cell, the current density was not reduced.

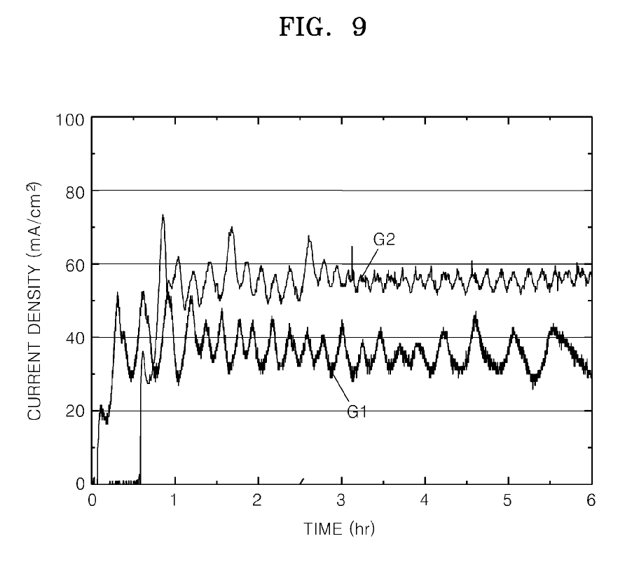

FIG. 9 illustrates changes of a current density, when output voltages of the first and second unit fuel cells were boosted by using a DC-DC converter. In FIG. 9, a first graph G1 illustrates a change of a current density in the first case, that is, in a case where an output voltage of the first unit fuel cell constructed with four unit cells connected in series was boosted by using the DC-DC converter. A second graph G2 illustrates a change of a current density in the second case, that is, in a case where an output voltage of the second unit fuel cell constructed with eight unit cells connected in series was boosted by using the DC-DC converter. Referring to FIG. 9, it can be noted that in the first case, the average current density was less than 40 mA/cm². In the second case, the average current density was less than 60 mA/cm². When FIG. 9 is compared with FIG. 8, the current densities were decreased in both the first and second case.

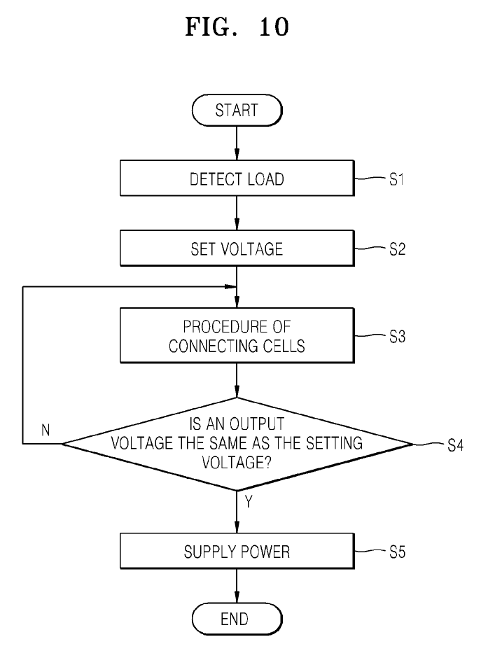

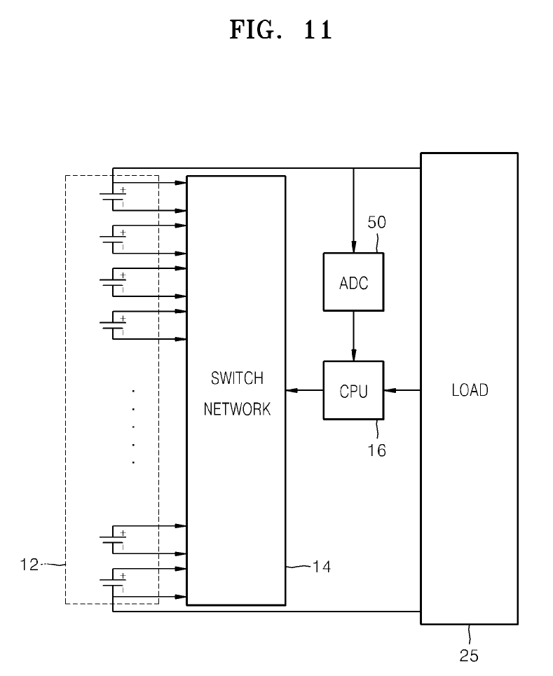

Next, a method of operating a fuel cell system according to an embodiment of the present invention, that is, a method of generating power required by a load 25, will be described. FIG. 10 is a flowchart of a method of operating a fuel cell system according to at least one example embodiment. FIG. 11 is a circuit diagram related to the method of operating the fuel cell system of FIG. 10.

Referring to FIG. 10 and FIG. 11, in the method of operating the fuel cell system according to the at least one example embodiment, the requirements of the load 25 may be determined first (operation S1). The requirements of the load 25 may be determined through a contact pad or an additional channel when the fuel cell system is connected to the load 25. It is possible to determine an operating voltage of the load 25, for example, a mobile phone, a PDA, a notebook computer, and the like, by recognizing the load 25. After the load 25 is recognized, an output voltage of the fuel cell system may be set according to the recognized information (operation S2). The output voltage substantially becomes the output voltage of the power generation unit 12. Since the load 25 is detected by the system control unit 16, the output voltage may be set by the system control unit 16. After the output voltage is set, unit cells included in the power generation unit 12 may be connected to one another to produce the set output voltage; that is, a connection process of unit cells may be performed (operation S3). Connection or disconnection states of unit cells of the power generation unit 12 are determined according to the on and off states of the switch array of the switch network 14. Therefore, a procedure of connecting unit cells of the power generation unit 12 to one another may be substantially the same as a procedure of establishing connections among switches of the switch network 14.

In a case where information on the switch array of the switch network 14 is stored in the system control unit 16, the establishment of the connections among the switches constituting the switch array of the switch network 14 by controlling a configuration of serial or parallel connections among the switches may be performed by the system control unit 16.

However, when the information on the switch array of the switch network 14 is stored in the switch network 14, the establishment of the connections among the switches of the switch network 14 may be performed by the switch network 14. It is assumed that all the switches of the switch array of the switch network 14 are initially switched off; however, aspects of the present invention are not limited thereto such that the switches of the switch array of the switch network 14 may be initially switched on or in different states of on and off.

Next, after completing the procedure of connecting unit cells of the power generation unit 12, it is determined whether the output voltage produced by the power generation unit 12 is the same as a voltage required by the load (operation S4). The result obtained by comparing the output voltage of the power generation unit 12 with a reference voltage is transmitted to the system control unit 16 through an analog to digital converter 50. When the output voltage produced by the power generation unit 12 is the same as the voltage required by the load 25 (Y), power is supplied to the load 25 (operation S5). However, when the output voltage produced by the power generation unit 12 is not the same as the voltage required by the load 25 (N), the operation (operation S3) of connecting the unit cells to one another and subsequent operations are performed again. When the operation (operation S3) is repeated, the voltage required by the load 25 is compared with the output voltage to detect a difference between the voltage required by the load 25 and the output voltage, and it is possible to establish connections among the switches so as to compensate for the difference.

Although a few embodiments of the present invention have been shown and described, it would be appreciated by those skilled in the art that changes may be made in this embodiment without departing from the principles and spirit of the invention, the scope of which is defined in the claims and their equivalents. For example, other on-off units except field effect transistors may be included between neighboring unit cells as switches. In addition, the unit cells may be vertically or horizontally stacked. Aspects of the present invention may be applied to a proton exchange membrane fuel cell (PEMFC) system or any other fuel cell system, in addition to a direct methanol fuel cell (DMFC) system.

What is claimed is:

1. A power unit of a fuel cell system, comprising:
a power generation unit comprising unit cells; and
a switch group to selectably connect the unit cells in series or in parallel according to a voltage required by a load connected to the fuel cell system.

2. The power unit of claim 1, wherein the switch group comprises:
a first switch connected between anodes of neighboring unit cells; and
a second switch connected between cathodes of the neighboring unit cells.

3. The power unit of claim 2, wherein the switch group further comprises a third switch connected between electrodes having opposite polarities of the neighboring unit cells.

4. The power unit of claim 1, wherein the fuel cell system is a direct methanol fuel cell (DMFC) or a proton exchange membrane fuel cell (PEMFC) system.

5. The power unit of claim 1, further comprising a switch network separate from the unit cells, the switch network comprising the switch group.

6. The power unit of claim 5, wherein the switch network is separate from the power generation unit.

7. The power unit of claim 1, wherein some of the unit cells are connected in parallel with one another, and the other of the unit cells are connected in series.

8. The power unit of claim 1, wherein the power unit determines the voltage required by the load to which the fuel cell system is connected.

9. A fuel cell system including a power unit to produce power to be applied to a load,
wherein the power unit comprises:
a power generation unit comprising unit cells, and
a switch group to selectably connect the unit cells in series or in parallel according to a voltage required by the load connected to the fuel cell system.

10. The fuel cell system of claim 9, wherein the switch group comprises:
a first switch connected between anodes of neighboring unit cells; and
a second switch connected between cathodes of the neighboring unit cells.

11. The fuel cell system of claim 9, wherein the switch group further comprises a switch connected between electrodes having opposite polarities of the neighboring unit cells.

12. The fuel cell system of claim 9, wherein the fuel cell system is a direct methanol fuel cell or a proton exchange membrane fuel cell.

13. The fuel cell system of claim 9, wherein the power unit further comprises a switch network separate from the unit cells, the switch network comprising the switch group.

14. The fuel cell system of claim 13, wherein the switch network is separate from the power generation unit.

15. The fuel cell system of claim 9, wherein some of the unit cells are connected in parallel with one another, and the other of the unit cells are connected in series.

16. The fuel cell system of claim 9, wherein the power unit determines the power to be applied to the load to which the fuel cell system is connected.

17. The fuel cell system of claim 14, wherein the power unit further comprises a system control unit, the system control unit comprising the switch network.

18. The fuel cell system of claim 10, wherein the switch group further comprises a third switch connected between electrodes of the neighboring unit cells, wherein the electrodes have polarities opposite to each other.

19. A method of operating a fuel cell system having a system control unit and a power generation unit comprising unit cells, the method comprising:
setting a voltage; and
connecting the unit cells so as to produce the set voltage.

20. The method of claim 19, wherein the setting of the voltage comprises:
recognizing a load; and
determining an operating voltage of the load as a voltage to be produced by the fuel cell system.

21. The method of claim 19, wherein the unit cells are connected in series and/or in parallel to produce the set voltage.

22. The method of claim 19, wherein the connecting of the unit cells comprises:
controlling a switch group to connect the unit cells in parallel or/and series.

23. The method of claim 22, wherein the switch group is included in a switch network of the fuel cell system or the system control unit.

24. The method of claim 22, wherein the switch group comprises two switches to connect two of the unit cells in parallel and one switch to connect two of the unit cells in series.

25. The method of claim 20, further comprising:
determining whether an output voltage of the power generation unit is the same as the set voltage; and
supplying the output voltage to the load when the output voltage is the same as the set voltage and newly establishing connections among the unit cells when the output voltage is not the same as the set voltage.
